(19) United States
(12) Patent Application Publication
(10) Pub. No.: US 2021/0372428 A1
(43) Pub. Date: Dec. 2, 2021

(54) HYBRIDIZATION OF THE FIBRES OF THE FIBROUS REINFORCEMENT OF A BLADE

(71) Applicant: SAFRAN AIRCRAFT ENGINES, Paris (FR)

(72) Inventors: Thomas Alain DE GAILLARD, Moissy-Cramayel (FR); Gilles Pierre-Marie NOTARIANNI, Moissy-Cramayel (FR); Frédéric Jean-Bernard POUZADOUX, Moissy-Cramayel (FR)

(73) Assignee: SAFRAN AIRCRAFT ENGINES, Paris (FR)

(21) Appl. No.: 17/290,491

(22) PCT Filed: Oct. 30, 2019
(86) PCT No.: PCT/EP2019/079748

§ 371 Date: Apr. 30, 2021

(30) Foreign Application Priority Data
Oct. 30, 2018 (FR) 1860029

(51) Int. Cl. F04D 29/38; F02C 7/00; B29C 70/24; D03D 25/00; D03D 15/275; D03D 15/283; D03D 15/56

(52) U.S. Cl. CPC F04D 29/388; F02C 7/00; B29C 70/24; D03D 25/005; B29L 2031/082; D03D 15/283; D03D 15/56; F05D 2220/36; F05D 2300/6034; D03D 15/275

(57) ABSTRACT

The invention relates to a blade (3) of a fan (1) of a turbomachine having a structure made of a composite material comprising a fibrous reinforcement (5) obtained by three-dimensional weaving and a matrix in which the fibrous reinforcement (5) is embedded, the fibrous reinforcement (5) comprising first strands (9) having a predetermined elongation at break, a portion of the fibrous reinforcement (5) further comprising second strands (10) having an elongation at break higher than that of the first strands (9).

### FIELD OF THE INVENTION

The invention relates generally to the field of gas turbine engines, and more particularly that of the fan blades of these gas turbine engines and their manufacturing process.

The invention is particularly applicable to fan blades made of composite material and their interaction with the inlet of the primary duct.

### TECHNOLOGICAL BACKGROUND

Gas turbine engine blades, and in particular fan blades, are subject to significant mechanical and thermal stresses and must meet strict weight and space requirements. It has therefore been proposed to use blades made of a composite material comprising a fibrous reinforcement densified with a polymer matrix, which are lighter than metal blades with equivalent propulsive characteristics and which have a satisfactory heat resistance.

During the certification and life of an engine, fan blades are subject to bird and hail ingestions. However, depending on the type of object impacting the blade (and in particular its size, its mass) and on the type of fan (rotation speed and number of blades), the preferred areas for damage initiation and propagation are different. The mechanical behavior of fan blades is therefore optimized during the design phase of the blades to comply with certification rules.

Furthermore, current designs tend to reduce the thickness of the composite material structure of blades in areas of the leading edge, the trailing edge, or indeed the entire structure to improve aerodynamic performance. At iso-material and iso-stacking law, the capacity of the blade to resist an impact is consequently reduced.

### SUMMARY OF THE INVENTION

An objective of the invention is therefore to remedy the above-mentioned drawbacks, by proposing a fan blade for a gas turbine engine with improved ingestion behavior.

To that end, the invention proposes a fan blade for a gas turbine engine comprising a composite material structure comprising a fibrous reinforcement obtained by three-dimensional weaving and a matrix in which the fibrous reinforcement is embedded, the fibrous reinforcement comprising first strands having a predefined elongation at break.

In addition, a portion of the fibrous reinforcement further comprises second strands having a higher elongation at break than the first strands.

Some preferred but non-limiting features of the above-described blade are the following, taken individually or in combination:

the blade further comprises a root and a tip, the fibrous reinforcement comprising a first portion comprising the root and a second portion comprising the tip, the first portion being devoid of second strands while the second portion comprises the second strands.

the second portion comprises warp strands and weft strands, the warp strands and/or weft strands of said second portion being devoid of first strands.

the first portion extends over a distance equal to at least 30% of a height of the blade, for example over a distance comprised between 30% and 65% of the height of the blade.

the fibrous reinforcement comprises a third portion extending between the first portion and the second portion, a density of the second strands progressively increasing in the third portion from the first portion to the second portion.

the third portion extends over a distance comprised between 5% and 30% of a height of the blade.

the third portion extends over a distance comprised between 1 cm and 10 cm.

the fibrous reinforcement is obtained by three-dimensional weaving of warp strands and weft strands, said warp strands defining a plurality of warp planes, each warp plane of the fibrous reinforcement being separated from an immediately adjacent warp plane by a line of weft strands, at most 30% of the warp and/or weft strands of the third portion being modified between two immediately adjacent warp planes.

between 5% and 15% of warp and/or weft strands of the third portion are modified between two immediately adjacent warp planes.

the first strands have a higher Young modulus than the second strands.

the elongation at break of the second strands is comprised between 1.5 and 3 times the elongation at break of the first strands.

the first strands comprise carbon or aramid fibers whose Young modulus is greater than 250 GPa and whose elongation at break is comprised between 1.5% and 2.5%.

the elongation at break of the second strands is comprised between 3% and 6%, preferably between 4% and 5%.

the second strands comprise glass or aramid fibers or basalt fibers.

the second strands comprise warp and/or weft threads.

According to a second aspect, the invention also provides a fan for a gas turbine engine comprising a plurality of blades as described above.

### BRIEF DESCRIPTION OF THE DRAWINGS

Other features, purposes and advantages of the present invention will become upon reading the following detailed description, and from the appended drawings, which are given by way of non-limiting examples and in which:

FIG. 1 is a schematic view representing an example of a fibrous reinforcement for a fan blade in accordance with an embodiment, in which the introduction of second strands and the exit of first strands into the intermediate portion have been schematized.

FIG. 2 is a schematic view representing an example of a fibrous reinforcement for a fan blade in which weft strands and four warp planes of the fibrous reinforcement of the blade have been schematized.

FIGS. 2a through 2d schematically illustrate the four warp planes shown in FIG. 2.

FIG. 2e schematically illustrates a partial weft plane of the fibrous reinforcement of FIG. 2.

FIG. 3 is a perspective view of an example embodiment of a fan comprising blades in accordance with the invention.

### DETAILED DESCRIPTION OF AN EMBODIMENT

In the present application, upstream and downstream are defined with respect to the normal flow direction of the gas in the fan 1 through the gas turbine engine. Furthermore, the axis of revolution of the fan 1 is referred to as the axis X of radial symmetry of the fan 1. The axial direction corresponds to the direction of the axis X of the fan 1, and a radial direction is a direction perpendicular to this axis and passing through it. Finally, internal and external will be used, respectively, in reference to a radial direction so that the internal part or face of an element is closer to the axis X than the external part or face of the same element.

A gas turbine engine fan 1 comprises a fan disk 2 carrying a plurality of fan blades 3 of the fan 1 associated with inter-blade platforms.

Each blade 3 comprises a composite material structure comprising a fibrous reinforcement 5 obtained by three-dimensional weaving and a matrix in which the fibrous reinforcement 5 is embedded.

This composite material structure comprises a root 6, an airfoil 7 having a leading edge 4 and a tip 8, and a shank extending between the root and the airfoil. The leading edge 4 corresponds to the edge of the airfoil 7 which is configured to face the flow of gases entering the fan 1.

Finally, the structure is formed of a plurality of blade sections stacked from the root 6 along a stacking axis Z extending radially with respect to the axis of revolution X of the fan 1.

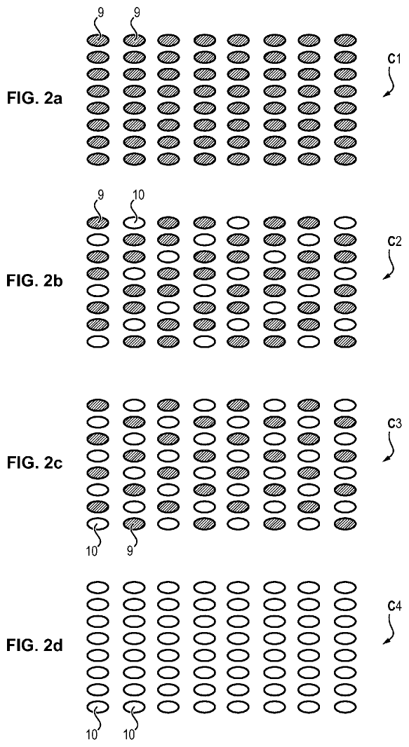

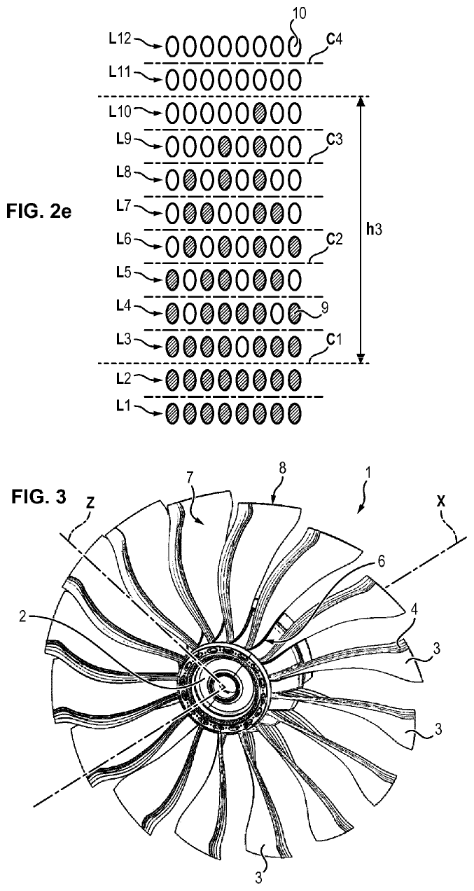

The root 6 of each blade 3 is engaged in an axial groove formed in the fan disk 2. As for the airfoil 7, it is suitable for extending into an air stream when the engine is operating so as to divide the air stream into a pressure flow and a suction flow in order to generate lift. The blade 3 has a height h corresponding to a dimension along the stacking axis Z of the blade sections between the root 6 and the tip 8. The height h can for example be measured at the intersection between the leading edge 4 and the lower boundary of the airfoil 7 (which corresponds to its interface with the shank, just above the root with respect to the leading edge 4 area). In particular, a percentage of height is considered with the total height of the blade measured from the inner end of the leading edge 4, i.e., at the connection of the leading edge 4 with the platform arranged on the inner side of the aerodynamic vein, to the end of the leading edge 4 at the blade tip. In FIG. 2, which shows the preform, the platform location is symbolized by a dotted line and marked by a reference 6a.

The fibrous reinforcement 5 can be formed from a single-piece fibrous preform obtained by three-dimensional or multilayer weaving with evolving thickness. It comprises fibers that can in particular be made of carbon, glass, basalt or aramid. The matrix, in turn, is typically a polymer matrix, for example epoxy, bismaleimide or polyimide. The blade 3 is then formed by molding by means of a resin injection process under vacuum of the resin transfer molding (RTM) or vacuum-assisted resin transfer molding (VARTM) type.

The fibrous reinforcement 5 comprises first strands 9 with a predefined elongation at break and second strands 10 with a higher elongation at break than that of the first strands 9. The fibrous reinforcement 5 is thus obtained by hybridization of the strands constituting it in order to make the best use of the mechanical properties of each strand according to the areas of the blade 3 and the type of stress.

The first strands 9 preferably have a high Young modulus, for example greater than 250 GPa, and have the function of enabling the design criteria of the blade 3 to be met, and in particular the frequency status of the blade 3. These first strands 9 are thus used in the weaving of the fibrous reinforcement 5 to form the portion of the reinforcement 5 (or internal portion 11) which comprises the root 6 of the blade 3 and a lower part of the airfoil 7, corresponding at least to the lower and thicker parts of the blade 3, so that the natural frequencies of the blade 3 are high. This thus makes it possible to limit or at least move away the frequency crossings between the first energetic normal modes of the blade 3 and the motor harmonics. The lower and thicker parts here include the root 6 of the blade 3 and the lower part of the airfoil 7. In an embodiment, only the first strands 9 are used as warp and weft threads in weaving the inner portion 11.

As for the second strands 10, whose breaking strength is greater than that of the first strands 9, their function is to limit the initiation and propagation of damage to the blade 3 when objects, and in particular birds, are ingested. These second strands 10 are therefore used in the weaving of the fibrous reinforcement 5 to form the portion of the reinforcement 5 (or external portion 12) which includes the tip 8. Preferably, the elongation at break of the second strands 10 is comprised between 1.5 and 3 times the elongation at break of the first strands 9. In an embodiment, only the second strands 10 are used as warp and weft threads in weaving the outer portion 12.

The reinforcement 5 further comprises an intermediate portion 13 extending between the inner portion 11 and the outer portion 12 that is formed by both the first strands 9 and the second strands 10. In an embodiment, only the first and second strands 9, 10 are used as warp and weft threads in weaving the intermediate portion 13.

This intermediate portion 13 is configured to serve as an interface between the first portion 11 and the second portion 12 in order to limit brittleness due to material discontinuities. When the fibrous reinforcement 5 comprises only first strands 9 in the first portion 11 of the blade 3 and only second strands 10 in the second portion 12 of the blade 3, and the first portion 11 and the second portion 12 are end-to-end in the reinforcement 5, the resulting blade 3 effectively prevents damage to the blade 3 in the areas comprising the second strands 10. However, the Applicant realized that in the absence of an intermediate portion 13, i.e., by abruptly introducing second strands 10 and simultaneously removing the first strands 9 at the interface between the first portion 11 and the second portion 12 of the fibrous reinforcement 5, the blade 3 obtained risked being heavily damaged at this interface in the event of an impact, because the interface between the two portions 11, 12 of the reinforcement 5 is weakened by the strong discontinuity of the material properties.

The intermediate portion 13 thus provides a transition between the material properties of the inner portion 11 and the material properties of the outer portion 12. To this end, the density of the second strands 10 is gradually increased within the intermediate portion 13 from the inner portion 11 to the outer portion 12. More precisely, at the interface 14 between the inner portion 11 and the intermediate portion 13, the density of the second strands 10 is very low while the density of the first strands 9 is very high. In contrast, at the interface 15 between the intermediate portion 13 and the outer portion 12, the density of the second strands 10 is very high while the density of the first strands 9 is very low.

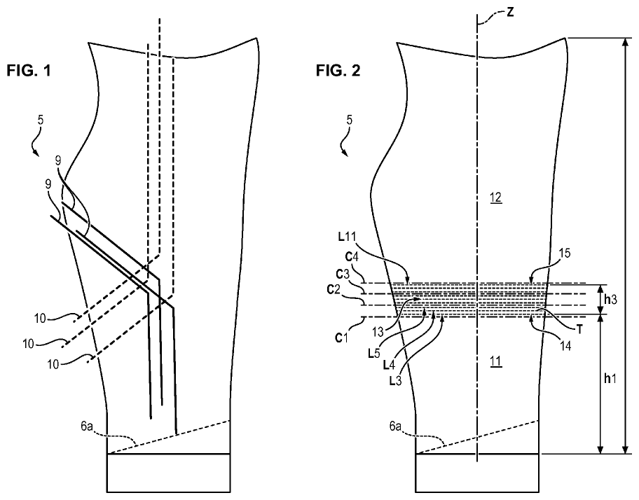

FIGS. 1 and 2 schematically represent a blade 3 whose fibrous reinforcement 5 has been shaped from a three-dimensionally woven fibrous preform, before resin injection or densification by a matrix and possible machining, in order to obtain a fan 1 blade 3 made of composite material in accordance with the invention. Three-dimensional weaving means that the warp threads follow sinuous paths in order to interlink weft threads belonging to different layers of weft threads, with the exception of unbindings, it being noted that a three-dimensional weaving, in particular with an interlock weave, can include 2D weaves on the surface. Different three-dimensional weaves can be used, such as interlock, multi-satin or multi-sheet weaves, for example, as described in particular in the document WO 2006/136755.

In order to produce the inner portion 11, the intermediate portion 13 and the outer portion 12 in one piece, the first strands 9 can be successively taken out of the preform weaving, at the level of the different warp planes of the intermediate portion 13, and cut at the level of the preform surface before injection, while the second strands 10 are progressively introduced in these warp planes (see FIG. 1).

Four examples of warp planes C11, C2, C3, C4 have been represented in FIG. 2. A warp plane C1-C4 is a cross-sectional view of the fiber preform along a plane normal to the stacking axis Z. In the fibrous reinforcement 5, each warp plane C1 to C4 is separated from the immediately adjacent warp plane by a line of weft strands. In FIG. 2, the warp planes C1 to C4 that have been shown are spaced in pairs by three lines of weft strands (L3 to L11).

Furthermore, FIGS. 2a to 2d each illustrate one of these four warp planes C1-C4, in which only the warp strands (i.e., in the direction of stacking of the sections) have been represented, the weft strands having been omitted in order to simplify the reading of the figures. These figures schematically illustrate a first example of hybridization of the strands, in which the second strands 10 are inserted in a warp plane.

As can be seen in FIG. 2a, the first warp plane C1, which is part of the inner portion 11 of the fibrous reinforcement 5, comprises only first strands 9. This first warp plane C1 is located at the interface 14 with the intermediate portion 13 of the reinforcement 5.

The second warp plane C2 (FIG. 2b) is part of the intermediate portion 13 of the fibrous reinforcement 5, near its interface 14 with the inner portion 11. This second warp plane C2 comprises twice as many first strands 9 as second strands 10.

The third warp plane C3 (FIG. 2c) is part of the intermediate portion 13 of the fibrous reinforcement 5, near its interface 15 with the outer portion 12. This third warp plane C3 comprises twice as many second strands 10 as first strands 9.

The fourth warp plane C4 (FIG. 2d) is part of the outer portion 12 of the fibrous reinforcement 5, at the interface 15 with the intermediate portion 13, and comprises only second strands 10.

A second example of strand hybridization, in which the second strands 10 are inserted in a weft plane, has been illustrated in FIG. 2e. A weft plane is a cross-sectional view of the fibrous preform along a plane including the stacking axis Z and substantially aligned with the axis X of rotation of the fan 1. The weft plane is here included in the sheet. A weft plane is formed by a plurality of lines of weft strands L1-L12, each line of weft strands being separated from the immediately adjacent line of weft strands by a warp plane (planes C1-C4 being illustrated here). It will be noted, analogously to FIGS. 2a-2d, only the weft strands (i.e., in the substantially axial direction) have been shown in FIG. 2e, with the warp strands omitted to simplify the reading of the figure.

As can be seen in this FIG. 2e, the first two lines of weft strands L1 and L2, which are part of the inner portion 11 of the fibrous reinforcement 5, comprise only first strands 9. These first two lines of weft strands L1, L2 are located at the interface 14 with the intermediate portion 13 of the reinforcement 5.

The third line of weft strands L3 is part of the intermediate portion 13 of the fibrous reinforcement 5, near its interface 14 with the inner portion 11. This third line of weft strands L3 comprises a single second strand. The subsequent lines of weft strands L4-L10 each comprise one more second strand than the immediately preceding line of weft strands, up to the eleventh and subsequent line of weft strands L11 which comprise only second strands 10 and thus form part of the outer portion 12 of the reinforcement 5.

In general, in order to ensure the transition of the mechanical properties between the inner portion 11 and the outer portion 12 of the reinforcement 5, at most 30% of the warp and/or weft strands are preferably modified between two immediately adjacent warp planes (i.e., separated by only one weft line T). Thus, between two successive warp planes, at most 30% of the first strands 9 are taken out of the fibrous preform forming the fibrous reinforcement 5 and cut at the surface, and as many second strands 10 are introduced into the fibrous preform from the surface in order to replace the first strands 9 taken out, whether they are warp strands or weft strands. Preferably, between 5% and 15% of the strands are modified between two immediately adjacent planes. It should be noted that, in an embodiment, both warp strands and weft strands may be replaced between two successive warp planes of the intermediate portion 13. This therefore amounts to combining the first and second embodiments described above.

The height h3 (distance along the stacking axis Z between the interfaces 14 and 15) of the intermediate portion 13 is determined according to the dimensioning of the blade 3, and more particularly to the chosen frequency strategy/ingestion dimensioning combination.

In general, the internal portion 11 extends from the root of the blade 3 over a distance at least equal to 30% of the height h of the blade 3 so that the thick area of the blade 3 is sufficiently stiff (thanks to the high Young modulus and the low elongation at break of the first strands 9) to guarantee compliance with the design criteria of the blade 3 and in particular the frequency status.

If the stiffness of the blade 3 allows it, the interface 14 between the inner portion 11 and the intermediate portion 13 can be positioned at a distance h1 (along the stacking axis Z, measured from the lower boundary of the airfoil 7) comprised between 30% and 65% of the height h of the blade 3. The introduction of the second strands 10 then makes it possible to improve the behavior of the blade 3 against impacts of heavy birds (the impact and damage concentration areas linked to the ingestion of these birds being located at a distance from the root of the blade 3 comprised between 30% and 70% of the height h of the blade 3) but also against impacts of medium birds The most critical damage is in the area of the blade 3, which extends over a distance comprised between 70% and 100% of the height h of the blade 3.

On the other hand, when the frequency or vibration aspect requires to keep a certain stiffness in the blade 3, the distance h1 between the blade root and the interface 14 from which second strands 10 are introduced into the fibrous reinforcement 5 can be greater than 65% of the height h of the blade 3. The introduction of the second strands 10 into the upper portion of the blade 3, starting from a distance h1 greater than 65% of the height h of the blade 3, reduces the stiffness of the blade 3. However, this drop in stiffness has only a slight impact on the natural frequencies of the blade 3 and the deviations at the tip 8 of the blade 3. On the other hand, it improves the resistance against medium and light birds impacts thanks to their elongation at break.

It follows that the dimensioning of the blade 3 makes it possible to determine the position of the interface 14 between the internal portion 11 and the intermediate portion 13, and more precisely the distance h1 from which second strands 10 can be introduced into the fibrous reinforcement, and thus, to combine the stiffness necessary for the frequency status (first strands 9) and the elongation at break (second strands 10) for the ingestion resistance. The height h3 of the intermediate portion 13 is comprised between 5% and 30% of the height h of the blade 3. Thus, the height h3 of the intermediate portion 13 may be between one centimeter and ten centimeters. The height h3 of the intermediate portion 13 can be determined as a function of the spacing between the warp planes and the percentage of strand modification between two successive warp planes. For example, for a spacing E between two warp planes equal to three millimeters and a percentage P of strand modifications between two warp planes equal to 10%, the height h3 can be defined as follows:

h3=E/P=30 mm

In an embodiment, the first strands 9 have a high Young modulus E, i.e., greater than 250 GPa, preferably greater than 270 GPa. Their elongation at break A is also between 1.5% and 2.5%.

For example, the first strands 9 may comprise carbon fibers, typically HS*T300 (E=284 GPa, A=1.5%), HS TR30S (E=356 GPa, A=1.9%) or HS T700 (E=395 GPa, A=2.1%) carbon fibers or high modulus aramid fibers of the Dupont Kevlar 49 type (E=302, A=2.4%).

The second strands 10 may then have an elongation at break comprised between 3% and 6%, preferably between 4% and 5%. For example, the second strands 10 may comprise glass fibers, typically E-GLASS type glass fibers (E=165 GPa, A=4.4%) or S-2 GLASS type glass fibers (E=267 GPa, A=5.2%), or basalt fibers (E=227 GPa, A=3%) or polyester fibers (E=268, A=3.5%).

In general, the configurations described are valid for engines whose fan can have an external diameter of about 1.8 meters to 3 meters. The number of fan blades can be equal to 16 or 18. Whatever the diameter of the fan, the number of fan blades will be reduced as much as possible. Among various criteria, a choice of parameters (in particular the distance h1) will depend more particularly on the behavior of the fan blade and the combination of “ingestion frequency/dimensioning”. Indeed, for the same engine target, it is possible to choose different strategies of frequency behaviors or frequency responses in different cases of ingestion, for example to push back the blade and blading responses by avoiding vibratory crossings with energetic harmonics of the engine. For example, it is possible to make choices in order to position these crossings at transient engine speeds.

The hybridization of the strands of the fibrous reinforcement 5 also opens up the field of design thanks to the additional contribution in mechanical strength. For example, it becomes possible to refine the profile of the blade 3 at the leading edge 4 or the trailing edge or over its entire height h in comparison with a blade 3 comprising only first strands 9 (with high Young modulus), which allows the mass of the blade 3 and the aerodynamic performance of the fan 1 to be optimized (by obtaining thinner profiles or by reducing the hub ratio, which is related to the decrease of the centrifugal force induced by the mass of the blade 3).

1. A fan blade comprising a composite material structure comprising a fibrous reinforcement obtained by three-dimensional weaving and a matrix in which the fibrous reinforcement is embedded, the fibrous reinforcement comprising first strands having a first predefined elongation at break, and, a root and a tip, the fibrous reinforcement comprising a first portion comprising the root and a second portion comprising the tip;
wherein part of the fibrous reinforcement further comprises second strands having a second elongation at break, the second elongation at break being greater than the first elongation at break;
wherein the first portion is devoid of second strands; and
wherein the second portion comprises the second strands.

2. The fan blade of claim 1, wherein the second portion comprises warp strands and weft strands, at least one of the warp strands and the weft strands being devoid of first strands.

3. The fan blade of claim 1, wherein the first portion extends over a distance equal to at least 30% of a height of the blade.

4. The fan blade of claim 1, wherein the fibrous reinforcement comprises a third portion extending between the first portion and the second portion, a density of the second strands progressively increasing in the third portion from the first portion toward the second portion.

5. The fan blade of claim 4, wherein the third portion extends over a distance comprised between 5% and 30% of a height of the blade.

6. The fan blade of claim 4, wherein the third portion extends over a distance comprised between 1 cm and 10 cm.

7. The fan blade of claim 4, wherein the fibrous reinforcement is obtained by three-dimensional weaving of warp strands and weft strands, said warp strands defining a plurality of warp planes, each warp plane being separated from an immediately adjacent warp plane by a line of weft strands, at most 30% of at least one of the warp and the weft strands of the third portion being modified between two immediately adjacent warp planes.

8. The fan blade of claim 7, wherein between 5 % and 15% of at least one of the warp strands and the weft strands of the third portion are modified between two immediately adjacent warp planes.

9. The fan blade of claim 1, wherein a Young modulus of the first strands is greater than a Young modulus of the second strands.

10. The fan blade of claim 1, wherein the second elongation at break is comprised between 1.5 and 3 times the first elongation at break.

11. The fan blade of claim 1, wherein the first strands comprise at least one of carbon fibers and aramid fibers, a Young modulus of the first strand being greater than 250 GPa and the first elongation at break being comprised between 1.5% and 2.5%.

12. The fan blade of claim 1, wherein the second elongation at break is comprised between 3% and 6%.

13. The fan blade as claimed in claim 12, wherein the second strands comprise at least one of glass fibers, aramid fibers, and basalt fibers.

14. The fan blade of claim 1, wherein the second strands comprise at least one of warp threads and weft threads.

15. A fan for a gas turbine engine comprising a plurality of fan blades as claimed in claim 1.

16. The fan blade of claim 1, wherein the first portion extends over a distance comprised between 30% and 65% of a height of the blade.

17. The fan blade of claim 1, wherein the second elongation at break is comprised between 4% and 5%

18. A gas turbine engine comprising a fan as claimed in claim 15.
